(19) United States
(12) Patent Application Publication
(10) Pub. No.: US 2021/0380780 A1
(43) Pub. Date: Dec. 9, 2021

(54) PLASTICIZER BLENDS

(71) Applicant: Eastman Chemical Company, Kingsport, TN (US)

(72) Inventors: Zhenpeng Li, Piney Flats, TN (US); Eric Jon Moskala, Kingsport, TN (US)

(73) Assignee: Eastman Chemical Company, Kingsport, TN (US)

(21) Appl. No.: 17/250,993

(22) PCT Filed: Nov. 8, 2019
(86) PCT No.: PCT/US2019/060404

§ 371 Date: Apr. 8, 2021

Related U.S. Application Data
(60) Provisional application No. 62/757,324, filed on Nov. 8, 2018.

(51) Int. Cl. C08K 5/00; C08K 5/06; C08K 5/103; C08K 5/12; C08K 5/11

(52) U.S. Cl. CPC C08K 5/0016; C08K 5/06; C08L 27/06; C08K 5/12; C08K 5/11; C08K 5/103

(57) ABSTRACT

The present invention relates to plasticizer compositions comprising a glycol ether, a dialkyl ether, or glycol ether ester; and certain plasticizers, which offer superior performance in blends containing polyvinyl chloride (PVC) resins. The plasticizer compositions of the present invention can effectively reduce viscosity and fusion temperature of PVC plastisols, and are particularly useful as viscosity control additives in plasticized PVC formulations.

### FIELD OF THE INVENTION

This invention belongs to the field of organic chemistry, more particularly to the field of plasticizers.

### BACKGROUND OF THE INVENTION

Polyvinyl chloride (commonly referred to as “PVC”) has been used for a number of years in the manufacture of soft, flexible films for food packaging, in molded rigid products (such as pipes, fibers, upholstery and bristles), and in a variety of other products, including electric wire and cable-coverings, film finishes for textiles, raincoats, belting, gaskets and shoe soles. A variety of plasticizers have been used to produce more flexible and/or soft PVC articles. Plasticizers can also assist in the fusion of the PVC formulation to produce the final article. In the typical fusion process, the PVC resin particles dissolve and/or break apart, intermingle with all the other additives to produce the final homogenously mixed material. Plasticizers that have a high affinity for PVC resin resulting in very quick fusion are often called high-solvating plasticizers or fast-fusing plasticizers. Fusion in dry blends is accomplished by a combination of stress and temperature. Fusion in plastisols occurs mainly by temperature. There are a number of chemical classes of high-solvating plasticizers such as benzoates, butyl benzyl phthalate, dihexyl phthalate, and others. High-solvating plasticizers provide faster fusion allowing fusion to occur at lower temperatures or to occur faster at a given temperature. A disadvantage for high solvating plasticizers is that they can result in PVC compositions that are less stable to viscosity increases. Plasticizer compositions that can produce higher solvation without unacceptably increasing viscosity of the resulting PVC compositions would be desirable.

It would be further advantageous if such plasticizers had low volatility, as this would reduce the loss of plasticizer product to emissions. It is also desirable for plasticizers to have a freezing point well below handling temperatures, as freezing creates processing challenges regarding handling and use.

### SUMMARY OF THE INVENTION

The present invention provides plasticizer compositions comprising certain plasticizers blended with a glycol ether, a dialkyl ether, or a glycol ether ester, which offer superior performance in plastisols containing polyvinyl chloride (PVC) resin. The plasticizer compositions of the present invention can effectively reduce viscosity and fusion temperature of PVC plastisols, and are particularly useful as viscosity control additives in plasticized PVC formulations. One objective of the present invention is to develop a plasticizer blend showing advantageous viscosity and fusion temperature.

In one embodiment, the plasticizer blends have a lower freezing temperature compared to some low viscosity and high solvating plasticizers. In one embodiment the plasticizer blends have reduced volatility as compared to some low viscosity and high solvating plasticizers. In one embodiment, the plasticizer blends have both a lower freezing temperature compared to some low viscosity and high solvating plasticizers and reduced volatility as compared to some low viscosity and high solvating plasticizers. In one embodiment, plasticizer blends have one or both of these favorable characteristics while also conveying lower viscosity, lower fusion temperature or both lower viscosity and lower fusion temperature to plastisols as compared to some low viscosity and high solvating plasticizers.

The compositions of the present invention can be used as a primary plasticizer having favorable or improved properties. Alternatively, the compositions of the present invention can be used as a secondary plasticizer or viscosity reducing additive to compositions that contain one or more additional plasticizers, thereby conveying favorable or improved properties.

### DETAILED DESCRIPTION OF THE INVENTION

### Definitions

As used herein, the terms “a,” “an,” and “the” mean one or more.

“Alkyl” groups suitable for use herein can be straight, branched or cyclic. Alkyl groups suitable for use herein include any (C₁₋₈), (C₁₋₄), or (C₁₋₂) alkyl groups. In some embodiments, all alkyl groups are linear or branched and none are cyclic.

The term “plastisol”, as used herein, refers to a liquid dispersion of polymeric resin particles, optionally with other ingredients, in a plasticizer.

The term “fused plastisol”, as used herein, refers to the solid plastic material that is formed upon fusing the plastisol and subsequently cooling to a desired temperature. The term “fusing”, as used herein, refers to heating of the plastisol to a temperature sufficient to yield a solid structure with mechanical integrity.

“Stabilizer” means any additive added to a formulation that can prevent that helps to prevent the formulation from degrading. Classes of stabilizers include antioxidants, light stabilizers, acid scavengers, heat stabilizers, flame retardants, and biocides.

“Antioxidants” are chemicals used to interrupt degradation processes during the processing of materials. Antioxidants are classified into several classes, including primary antioxidant, and secondary antioxidant.

“Primary antioxidants” are antioxidants that act by reacting with peroxide radicals via a hydrogen transfer to quench the radicals. Primary antioxidants generally contain reactive hydroxy or amino groups such as in hindered phenols and secondary aromatic amines. Examples of primary antioxidants include Cyanox™ 1790, 2246, and 425; Topanol® CA (4-[4,4-bis(5-tert-butyl-4-hydroxy-2-methylphenyl)butan-2-yl]-2-tert-butyl-5-methylphenol), Irganox™ 1010, 1076, 1726, 245, 1098, 259, and 1425; Ethanox™ 310, 376, 314, and 330; Evernox™ 10, 76, 1335, 1330, 3114, MD 1024, 1098, 1726, 120. 2246, and 565; Anox™ 20, 29, 330, 70, IC-14, and 1315; Lowinox™ 520, 1790, 221646, 22M46, 44625, AH25, GP45, CA22, CPL, HD98, TBM-6, and WSP; Naugard™ 431, PS48, SP, and 445; Songnox™ 1010, 1024, 1035, 1076 CP, 1135 LQ, 1290 PW, 1330FF, 1330PW, 2590 PW, and 3114 FF; and ADK Stab AO-20, AO-30, AO-40, AO-50, AO-60, AO-80, and AO-330.

“Phenolic antioxidants” are primary antioxidants having at least one phenolic moiety. Non-limiting examples include Cyanox 1790, Cyanox 2246, Cyanox 425, Ethanox 330, Irganox 1330, Irganox 245, Irganox 259, Irganox 1010, Irganox 1035, Irganox 1076, Irganox 1098, Irganox 1425, Irganox 3114, and Topanol CA.

“Secondary antioxidants” are often called hydroperoxide decomposers. They act by reacting with hydroperoxides to decompose them into nonreactive and thermally stable products that are not radicals. They are often used in conjunction with primary antioxidants. Examples of secondary antioxidants include the organophosphorous (e.g., phosphites, phosphonites) and organosulfur classes of compounds. The phosphorous and sulfur atoms of these compounds react with peroxides to convert the peroxides into alcohols. Examples of secondary antioxidants include Ultranox 626, Ethanox™ 368, 326, and 327; Doverphos™ LPG11, LPG12, DP S-680, 4, 10, S480, and S-9228; Evernox™ 168 and 626; Irgafos™ 126 and 168; Weston™ DPDP, DPP, EHDP, PDDP, TDP, TLP, and TPP; Mark™ CH 302, CH 55, TNPP, CH66, CH 300, CH 301, CH 302, CH 304, and CH 305; ADK Stab 2112, HP-10, PEP-8, PEP-36, 1178, 135A, 1500, 3010, C, and TPP; Weston 439, DHOP, DPDP, DPP, DPTDP, EHDP, PDDP, PNPG, PTP, PTP, TDP, TLP, TPP, 398, 399, 430, 705, 705T, TLTTP, and TNPP; Alkanox 240, 626, 626A, 627AV, 618F, and 619F; and Songnox™ 1680 FF, 1680 PW, and 6280 FF.

“Acid scavengers” are additives that neutralize acids formed during the processing of polymers. Examples of acid scavengers include Hycite 713; Kisuma DHT-4A, DHT-4V, DHT-4A-2, DHT-4C, ZHT-4V, and KW2200; Brueggemann Chemical Zinc Carbonate RAC; Sipax™ AC-207; calcium stearate; Baerlocher GL 34, RSN, GP, and LA Veg; Licomont CAV 102; FACI Calcium Stearate DW, PLC, SP, and WLC; Hangzhou Hitech Fine Chemical: CAST, and ZnST; Songstab™ SC-110, SC-120, SC-130, SM-310, and SZ-210; Sun Ace SAK-CS, SAK-DSC, SAK-DMS, SAK-DZS, and SAK-KS; US Zinc Oxide 201, 205 HAS, 205H, 210, and 210E; Drapex™ 4.4, 6.8, 39, 391, 392, and 392S; Vikoflex™ 4050, 5075, 7170, 7190, 7040, 9010, 9040, and 9080; Joncryl™ ADR 4468, and ADR 4400; Adeka CIZER D-32; Epon™ 1001F, 1002F, and 1007F; Aralidite™ ECN 1299, 1273, 1280, 1299, and 9511; Dynamar RC 5251Q; and Nexamite PBO.

A “salt stabilizer” can be incorporated into the composition to stabilize the composition during processing. The cation component of the salt stabilizer is chosen from aluminum, calcium, magnesium, copper, cerium, antimony, nickel, cobalt, manganese, barium, strontium, zinc, zirconium, tin, cadmium, chromium and iron cations; and the anion component of the salt stabilizer is an (C₆₋₂₀)alicyclic carboxylic acid, a (C₂₋₂₀)alkyl carboxylic acid, or a (C₆₋₂₀)alkenyl carboxylic acid. Examples of the (C₆₋₂₀)alicyclic carboxylic acid, the (C₆₋₂₀)alkyl carboxylic acid, or the (C₆₋₂₀)alkenyl carboxylic acid include naphthenic acid, abietic acid, cyclohexane carboxylic acid, cyclohexane propionic acid, 3-methyl-cyclopentyl acetic acid, 4-methylcyclohexane carboxylic acid, 2,2,6-trimethylcyclohexane carboxylic acid, 2,3-dimethylcyclopentyl acetic acid, 2-methylcyclopentyl propionic acid, palmitic acid, stearic acid, oleic acid, lauric acid, and the like. Examples of the salt stabilizers include strontium naphthenate, copper naphthenate, calcium naphthenate, zinc naphthenate, magnesium naphthenate, copper abietate, magnesium abietate, titanium acetate, titanium propionate, titanium butyrate, antimony acetate, antimony propionate, antimony butyrate, zinc acetate, zinc propionate, zinc butyrate, tin acetate, tin propionate, tin butyrate, 2-ethylhexylamine, bis(2-ethylhexyl)amine, tetrabutyl phosphonium bromide, dodecyldimenylamine, N,N-dimentylbenzylamine, tetramethyl guanidine, benzyltimethyl ammonium hydroxide, tetrabutyl ammonium hydroxide, 2-ethylimidazole, DBU/2-ethylheaxnoic acid, aluminum acetylacetonate, aluminate lactate, bismuth octoate, calcium octoate, cerium naphthenate, chromium(III) 2-ethylhexanoate, cobalt octoate, copper II acetylacetonate, Iron (III) acetylacetonate, manganese naphthenate, nickel acetylacetonate, stannous octoate, zinc acetate, zinc acetylacetonate, zinc octoate, zirconium octoate, and the like.

“Flame retardant” are materials that increase ignition time, reduce flame spreading and rate of burning. The flame retardant should have a high decomposition temperature, low volatility, a minimum effect on thermal and mechanical properties and good resistance to light and ultra-violet radiation. Examples of flame retardants that may be used include halogen containing compounds and phosphorous containing organic compounds such as triaryl, trialkyl or alkyl diaryl phosphate esters. Other materials that may be used include chloroparaffins, aluminum trihydrate, antimony oxides, or zinc borate

“Fillers” are materials added to formulations or compositions primarily to reduce cost, increase the output of dry blending, increase electrical resistance, increase resistance to ultra-violet light, increase hardness, provide improved heat transmission, and to increase the resistance of heat deformation. Fillers can also impact anti-blocking or anti-slip performance of the compositions. Nonlimiting examples of fillers included calcium carbonate, clays, silica, dolomite, bauxite, titanium dioxide. The particular particle size distribution and average surface area of the filler will be chosen according to the properties it is desired to impart, as would be apparent to one of skill in the art.

“Processing aids” are chemicals that reduce the adhesion of the compositions with machinery surfaces during processing. The lubricants also affect the frictional properties between the polymer resin particles during processing. Nonlimiting examples of lubricants include stearic acid, metal stearates, waxes, silicon oil, mineral oil, and synthetic oils.

As used herein the term “chosen from” when used with “and” or “or” have the following meanings: A variable chosen from A, B and C means that the variable can be A alone, B alone, or C alone. A variable A, B, or C means for example that the variable can be A alone, B alone, C alone, A and B in combination, A and C in combination, B and C in combination, or A, B, and C in combination.

### Abbreviations

° C. is degree(s) Celsius; cP is centipoise. Ex is example. Comp is comparative. phr is parts per hundred PVC resin. PVC is polyvinyl chloride. EB is ethylene glycol monobutyl ether (2-butoxyethan-1-01). ESO is epoxidized soybean oil. DBT is di-n-butyl terephthalate, also known as dibutyl terephthalate. DIBT is di-isobutyl terephthalate. Mixed ester C₄ terephthalate is a terephthalate in which one C₄ group is linear and one C₄ group is branched. DPT is dipentyl terephthalate, which can be any C₅ terephthalate or combination of C₅ terephthalates. In one embodiment, both C₅ groups in the DPT molecule are linear. In one embodiment, both C₅ groups in the DPT molecule are branched. In one embodiment, one C₅ group in the DPT molecule is linear and the other C₅ group is branched. In one embodiment, the DPT is a blend of terephthalates in which both C₅ groups are linear with terephthalates in which both C₅ groups are linear branched. In one embodiment, the DPT is a blend of terephthalates in which both C₅ groups are linear with terephthalates in which one C₅ group is linear and the other C₅ group is branched. In one embodiment, the DPT is a blend of terephthalates in which both C₅ groups are branched with terephthalates in which one C₅ group is linear and the other C₅ group is branched. In one embodiment, the DPT is a blend of terephthalates in which both C₅ groups are linear with terephthalates in which both C₅ groups are branched and terephthalates in which one C₅ group is linear and the other C₅ group is branched. DOA is dioctyl adipate, also known as bis(2-ethylhexyl) adipate. DOTP is dioctyl terephthalate or bis(2-ethylhexyl) terephthalate. min(s) is minute(s). mm is millimeter(s). rpm is revolutions per minute. Temp is temperature; weight % is weight percent;
In a first aspect, the invention provides a plasticizer blend comprising: (i) a compound of formula I:

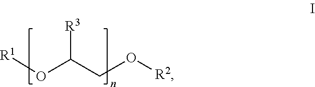

wherein:
R¹ and R² are independently hydrogen, (C₁-C₈)alkyl, or (C₁-C₈)alkyl-C(O)—, R³ is hydrogen or (C₁-C₈)alkyl, and n is an integer of from 1 to 3; and

(ii) a plasticizer, wherein said plasticizer, when combined at 60 parts per hundred polyvinyl chloride resin (“phr”) with components consisting of (a) and (b) to form a reference plastisol, with (a) and (b) being:

(a) a polyvinyl chloride resin, said polyvinyl chloride resin being a homopolymer having a K value of 74 at 100 phr, and

(b) an epoxidized soybean oil having 7.0 percent oxirane oxygen content at 3 phr,

provides the reference plastisol having a fusion temperature of less than 121° C., as measured using a TA Instruments DHR-1 parallel plate rheometer fitted with an environmental test chamber, 25 mm parallel plate geometry, set to a 1000 micron gap with a temperature sweep from 40-150° C. run in oscillation mode with a heating rate of 5° C./min, wherein the fusion temperature is defined as the maximum temperature of the complex viscosity curve.

As used herein, “K value” is determined pursuant to the procedures set forth in ISO International Standard 1628-2 (Second Edition, 1998-12-01). One example of polyvinyl chloride resins having a K value of 74 at 100 phr is Geon 121A PVC resin from PolyOne Corporation, Avon Lake, Ohio.

Any compound having the structure of Formula I may be used. In one embodiment, no more than one of R¹ or R² is hydrogen. In one class of this embodiment, R¹ and R² are independently hydrogen, (C₁-C₈)alkyl, or (C₁-C₄)alkyl-C(O)—. In one subclass of this class, R³ is hydrogen. In one subclass of this class, R³ is hydrogen or (C₁-C₄)alkyl. In one subclass of this class, R³ is hydrogen or (C₁-C₂)alkyl. In one subclass of this class, R³ is hydrogen or (C₁)alkyl. In one subclass of this class, n is 1 or 2. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 2 or 3. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 1. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 2. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 3. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one class of this embodiment, R¹ and R² are independently hydrogen, (C₁-C₈)alkyl, or (C₁-C₂)alkyl-C(O)—. In one subclass of this class, R³ is hydrogen. In one subclass of this class, R³ is hydrogen or (C₁-C₄)alkyl. In one subclass of this class, R³ is hydrogen or (C₁-C₂)alkyl. In one subclass of this class, R³ is hydrogen or (C₁)alkyl. In one subclass of this class, n is 1 or 2. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 2 or 3. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 1. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 2. In one subclass of this class, n is 3. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one class of this embodiment, R¹ and R² are independently hydrogen, (C₁-C₄)alkyl, or (C₁-C₄)alkyl-C(O)—. In one subclass of this class, R³ is hydrogen. In one subclass of this class, R³ is hydrogen or (C₁-C₄)alkyl. In one subclass of this class, R³ is hydrogen or (C₁-C₂)alkyl. In one class of this embodiment, R¹ and R² are independently hydrogen, (C₁-C₄)alkyl, or (C₁-C₂)alkyl-C(O)—. In one subclass of this class, R³ is hydrogen. In one subclass of this class, R³ is hydrogen or (C₁-C₄)alkyl. In one subclass of this class, R³ is hydrogen or (C₁-C₂)alkyl. In one subclass of this class, n is 1 or 2. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 2 or 3. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 1. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 2. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 3. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one class of this embodiment, R³ is hydrogen. In one class of this embodiment, R³ is hydrogen or (C₁-C₄)alkyl. In one class of this embodiment, R³ is hydrogen or (C₁-C₂)alkyl. In one class of this embodiment, R³ is hydrogen or (C₁)alkyl. In one class of this embodiment, no more than one of R¹ or R² contains an alkyl-C(O)—. In one subclass of this class, R³ is hydrogen. In one subclass of this class, R³ is hydrogen or (C₁-C₄)alkyl. In one subclass of this class, R³ is hydrogen or (C₁-C₂)alkyl. In one subclass of this class, n is 1 or 2. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 2 or 3. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 1. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 2. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 3. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl.

In one class of this embodiment, R¹ and R² are independently hydrogen, (C₁-C₈)alkyl, or (C₁-C₄)alkyl-C(O)—. In one subclass of this class, R³ is hydrogen. In one subclass of this class, R³ is hydrogen or (C₁-C₄)alkyl. In one subclass of this class, R³ is hydrogen or (C₁-C₂)alkyl. In one subclass of this class, n is 1 or 2. In one subclass of this class, n is 2 or 3. In one subclass of this class, n is 1. In one subclass of this class, n is 2. In one subclass of this class, n is 3.

In one class of this embodiment, R¹ and R² are independently hydrogen, (C₁-C₈)alkyl, or (C₁-C₂)alkyl-C(O)—. In one subclass of this class, R³ is hydrogen. In one subclass of this class, R³ is hydrogen or (C₁-C₄)alkyl. In one subclass of this class, R³ is hydrogen or (C₁-C₂)alkyl. In one subclass of this class, n is 1 or 2. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 2 or 3. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 1. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 2. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 3. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl.

In one class of this embodiment, R¹ and R² are independently hydrogen, (C₁-C₄)alkyl, or (C₁-C₄)alkyl-C(O)—. In one subclass of this class, R³ is hydrogen. In one subclass of this class, R³ is hydrogen or (C₁-C₄)alkyl. In one subclass of this class, R³ is hydrogen or (C₁-C₂)alkyl. In one subclass of this class, R¹ and R² are independently hydrogen, (C₁-C₄)alkyl, or (C₁-C₂)alkyl-C(O)—. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one sub-subclass of this subclass, n is 1 or 2. In one sub-sub-subclass of this sub-subclass, R³ is hydrogen. In one sub-sub-subclass of this sub-subclass, R³ is hydrogen or (C₁-C₄)alkyl. In one sub-sub-subclass of this sub-subclass, R³ is hydrogen or (C₁-C₂)alkyl. In one sub-sub-subclass of this sub-subclass, R³ is hydrogen or (C₁)alkyl. In one sub-subclass of this subclass, n is 2 or 3. In one sub-sub-subclass of this sub-subclass, R³ is hydrogen. In one sub-sub-subclass of this sub-subclass, R³ is hydrogen or (C₁-C₄)alkyl. In one sub-sub-subclass of this sub-subclass, R³ is hydrogen or (C₁-C₂)alkyl. In one sub-sub-subclass of this sub-subclass, R³ is hydrogen or (C₁)alkyl. In one sub-subclass of this subclass, n is 1. In one sub-sub-subclass of this sub-subclass, R³ is hydrogen. In one sub-sub-subclass of this sub-subclass, R³ is hydrogen or (C₁-C₄)alkyl. In one sub-sub-subclass of this sub-subclass, R³ is hydrogen or (C₁-C₂)alkyl. In one sub-sub-subclass of this sub-subclass, R³ is hydrogen or (C₁)alkyl. In one sub-subclass of this subclass, n is 2. In one sub-sub-subclass of this sub-subclass, R³ is hydrogen. In one sub-sub-subclass of this sub-subclass, R³ is hydrogen or (C₁-C₄)alkyl. In one sub-sub-subclass of this sub-subclass, R³ is hydrogen or (C₁-C₂)alkyl. In one sub-sub-subclass of this sub-subclass, R³ is hydrogen or (C₁)alkyl. In one sub-subclass of this subclass, n is 3. In one sub-sub-subclass of this sub-subclass, R³ is hydrogen. In one sub-sub-subclass of this sub-subclass, R³ is hydrogen or (C₁-C₄)alkyl. In one sub-sub-subclass of this sub-subclass, R³ is hydrogen or (C₁-C₂)alkyl. In one sub-sub-subclass of this sub-subclass, R³ is hydrogen or (C₁)alkyl.

In one embodiment, no more than one of R¹ or R² contains an alkyl-C(O)—. In one class of this embodiment, R³ is hydrogen. In one class of this embodiment, R³ is hydrogen or (C₁-C₄)alkyl. In one class of this embodiment, R³ is hydrogen or (C₁-C₂)alkyl. In one class of this embodiment, R¹ and R² are independently hydrogen, (C₁-C₈)alkyl, or (C₁-C₄)alkyl-C(O)—. In one subclass of this class, R³ is hydrogen. In one subclass of this class, R³ is hydrogen or (C₁-C₄)alkyl. In one subclass of this class, R³ is hydrogen or (C₁-C₂)alkyl. In one subclass of this class, n is 1 or 2. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 2 or 3. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 1. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 2. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 3. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one class of this embodiment, R¹ and R² are independently hydrogen, (C₁-C₈)alkyl, or (C₁-C₂)alkyl-C(O)—. In one subclass of this class, R³ is hydrogen. In one subclass of this class, R³ is hydrogen or (C₁-C₄)alkyl. In one subclass of this class, R³ is hydrogen or (C₁-C₂)alkyl. In one subclass of this class, n is 1 or 2. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 2 or 3. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 1. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 2. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 3. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one class of this embodiment, R¹ and R² are independently hydrogen, (C₁-C₄)alkyl, or (C₁-C₄)alkyl-C(O)—. In one subclass of this class, R³ is hydrogen. In one subclass of this class, R³ is hydrogen or (C₁-C₄)alkyl. In one subclass of this class, R³ is hydrogen or (C₁-C₂)alkyl. In one subclass of this class, n is 1 or 2. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 2 or 3. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 1. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 2. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 3. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl.

In one class of this embodiment, R¹ and R² are independently hydrogen, (C₁-C₄)alkyl, or (C₁-C₂)alkyl-C(O)—. In one subclass of this class, R³ is hydrogen. In one subclass of this class, R³ is hydrogen or (C₁-C₄)alkyl. In one subclass of this class, R³ is hydrogen or (C₁-C₂)alkyl. In one subclass of this class, n is 1 or 2. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 2 or 3. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 1. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 2. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 3. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl.

In one class of this embodiment, no more than one of R¹ or R² contains an alkyl-C(O)—. In one subclass of this class, R³ is hydrogen. In one subclass of this class, R³ is hydrogen or (C₁-C₄)alkyl. In one subclass of this class, R³ is hydrogen or (C₁-C₂)alkyl. In one subclass of this class, n is 1 or 2. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 2 or 3. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 1. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 2. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, n is 3. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one subclass of this class, R¹ and R² are independently hydrogen, (C₁-C₈)alkyl, or (C₁-C₄)alkyl-C(O)—. In one sub-subclass of this subclass, R³ is hydrogen. In one sub-subclass of this subclass, R³ is hydrogen or (C₁-C₄)alkyl. In one sub-subclass of this subclass, R³ is hydrogen or (C₁-C₂)alkyl. In one sub-subclass of this subclass, R³ is hydrogen or (C₁)alkyl. In one sub-subclass of this subclass, n is 1 or 2. In one sub-sub-subclass of this sub-subclass, R³ is hydrogen. In one sub-sub-subclass of this sub-subclass, R³ is hydrogen or (C₁-C₄)alkyl. In one sub-sub-subclass of this sub-subclass, R³ is hydrogen or (C₁-C₂)alkyl. In one sub-sub-subclass of this sub-subclass, R³ is hydrogen or (C₁)alkyl. In one sub-subclass of this subclass, n is 2 or 3. In one sub-sub-subclass of this sub-subclass, R³ is hydrogen. In one sub-sub-subclass of this sub-subclass, R³ is hydrogen or (C₁-C₄)alkyl. In one sub-sub-subclass of this sub-subclass, R³ is hydrogen or (C₁-C₂)alkyl. In one sub-sub-subclass of this sub-subclass, R³ is hydrogen or (C₁)alkyl. In one sub-subclass of this subclass, n is 1. In one sub-sub-subclass of this sub-subclass, R³ is hydrogen. In one sub-sub-subclass of this sub-subclass, R³ is hydrogen or (C₁-C₄)alkyl. In one sub-sub-subclass of this sub-subclass, R³ is hydrogen or (C₁-C₂)alkyl. In one sub-sub-subclass of this sub-subclass, R³ is hydrogen or (C₁)alkyl. In one sub-subclass of this subclass, n is 2. In one sub-subclass of this subclass, n is 3. In one sub-sub-subclass of this sub-subclass, R³ is hydrogen. In one sub-sub-subclass of this sub-subclass, R³ is hydrogen or (C₁-C₄)alkyl. In one sub-sub-subclass of this sub-subclass, R³ is hydrogen or (C₁-C₂)alkyl. In one sub-sub-subclass of this sub-subclass, R³ is hydrogen or (C₁)alkyl.

In one embodiment, R¹ and R² are independently hydrogen, (C₁-C₈)alkyl, or (C₁-C₄)alkyl-C(O)—. In one embodiment, R¹ and R² are independently hydrogen, (C₁-C₈)alkyl, or (C₁-C₂)alkyl-C(O)—. In one embodiment, R¹ and R² are independently hydrogen, (C₁-C₄)alkyl, or (C₁-C₄)alkyl-C(O)—. In one embodiment, R¹ and R² are independently hydrogen, (C₁-C₄)alkyl, or (C₁-C₂)alkyl-C(O)—.

In one embodiment, R³ is hydrogen. In embodiment, R³ is hydrogen or (C₁-C₄)alkyl. In one embodiment, R³ is hydrogen or (C₁-C₂)alkyl.

Embodiments exist in which n is 1-3 or any number or range within the range 1-3. In one embodiment, n is 1 or 2. In one embodiment, n is 1 or 2. In one embodiment, n is 2 or 3. In one embodiment, n is 1. In one embodiment, n is 2. In one embodiment, n is 3. In one class of this embodiment, n is 1 or 2. In one class of this embodiment, n is 1 or 2. In one class of this embodiment, n is 2 or 3. In one class of this embodiment, n is 1. In one class of this embodiment, n is 2. In one class of this embodiment, n is 3.

Exemplary compounds of formula I include but are not limited to, glycol ethers (e.g., ethylene glycol monobutyl ether (EB), ethylene glycol monoethyl ether, diethylene glycol monoethyl ether (DE), diethylene glycol monopropyl ether (DP), ethylene glycol 2-ethylhexyl ether (EEH) and diethylene glycol monobutyl ether(DB)), dialkyl ethers (e.g., ethylene glycol dimethyl ether, ethylene glycol diethyl ether and ethylene glycol dibutyl ether) and glycol ether esters (e.g., ethylene glycol monoethyl ether acetate, ethylene glycol monobutyl ether acetate, diethylene glycol monobutyl ether acetate (DBA), and diethylene glycol monoethyl ether acetate (DEA)). Certain of these compounds can be obtained commercially from Eastman Chemical Company, for example, Eastman DE solvent (diethylene glycol monoethyl ether), Eastman DB solvent (diethylene glycol monobutyl ether), Eastman PM acetate (propylene glycol monomethyl ether acetate), Eastman EB acetate (ethylene glycol monobutyl ether acetate), Eastman PM Solvent (PM or propylene glycol monomethyl ether), Eastman DM Solvent (diethylene glycol methyl ether), Eastman PB Solvent (propylene glycol monobutyl ether, Eastman DE Solvent (diethylene glycol ethyl ether), Eastman PP Solvent (propylene glycol monopropyl ether), Eastman EP Solvent (ethylene glycol monopropyl ether), Eastman EB Solvent (ethylene glycol monobutyl ether).

In one embodiment, the compound of formula I is chosen from ethylene glycol monobutyl ether, ethylene glycol monoethyl ether, diethylene glycol monopropyl ether, diethylene glycol monobutyl ether, ethylene glycol dimethyl ether, ethylene glycol diethyl ether, ethylene glycol dibutyl ether, ethylene glycol monoethyl ether acetate, ethylene glycol monobutyl ether acetate, and ethylene glycol monoethyl ether acetate. In one embodiment, the plasticizer blend contains two or more of the foregoing compounds.

In one embodiment, the compound of formula I is chosen from ethylene glycol monobutyl ether, diethylene glycol monobutyl ether, ethylene glycol 2-ethylhexyl ether, propylene glycol monomethyl ether, diethylene glycol monoethyl ether, diethylene glycol monopropyl ether, diethylene glycol monobutyl ether acetate and diethylene glycol monoethyl ether acetate. In one class of this embodiment, the plasticizer blend contains two or more of the foregoing compounds.

In one embodiment, the compound of formula I is chosen from ethylene glycol monobutyl ether, ethylene glycol monoethyl ether, diethylene glycol monopropyl ether, diethylene glycol monobutyl ether and ethylene glycol dimethyl ether. In one class of this embodiment, the plasticizer blend contains two or more of the foregoing compounds.

In one embodiment, the compound of formula I is chosen from ethylene glycol monobutyl ether and diethylene glycol monobutyl ether. In one embodiment, the plasticizer blend contains both of the foregoing compounds.

The plasticizer may be any compound which, when combined at 60 parts per hundred polyvinyl chloride resin (“phr”) with components consisting of (a) and (b) to form a reference plastisol, with (a) and (b) being:

(a) a polyvinyl chloride resin, said polyvinyl chloride resin being a homopolymer having a K value of 74 at 100 phr, and

(b) an epoxidized soybean oil having 7.0 percent oxirane oxygen content at 3 phr,

provides the reference plastisol having a fusion temperature of less than 121° C., as measured using a TA Instruments DHR-1 parallel plate rheometer fitted with an environmental test chamber, 25 mm parallel plate geometry, set to a 1000 micron gap with a temperature sweep from 40-150° C. run in oscillation mode with a heating rate of 5° C./min, wherein the fusion temperature is defined as the maximum temperature of the complex viscosity curve.

In one embodiment, the plasticizer (ii) is selected from di-n-butyl terephthalate (also referred to as DBT or dibutyl terephthalate), DIBT, mixed ester C₄ terephthalate, dipentyl terephthalate, butyl benzyl phthalate, dihexyl phthalate and benzoate type plasticizers that will form the reference plastisol having the characteristics described above under the conditions described above. As used herein, “benzoate type plasticizers” refers to molecules that can be made by esterifying a monovalent or divalent alcohol with one or two benzoic acid molecules. Some examples of benzoate type plasticizers include isononyl benzoate, isodecyl benzoate, 2,2,4 trimethyl-1,3 pentane diol dibenzoate, 2,2,-dimethyl-1,3 propanediol dibenzoate, ethylene glycol benzoate, diethylene glycol benzoate, and triethylene glycol benzoate. As noted above, the plasticizer component (ii) is defined by its performance characteristics in a plastisol composition as the sole plasticizer as defined above and in the experimental section below. In other words, in the contemplated plasticizer blends and plastisols, the plasticizer (ii) is defined using this test method as the means for determining its inclusion within the scope of “plasticizers” of component (ii). In one embodiment, the plasticizer (ii) is selected from DBT, dipentyl terephthalate (DPT), butyl benzyl phthalate and dipropylene glycol di-benzoate. In one embodiment, the plasticizer (ii) is selected from DBT, dipentyl terephthalate (DPT) and dipropylene glycol di-benzoate. Embodiments using two or more plasticizers of component (ii) are also within the invention.

In one embodiment, the compound of formula I is chosen from ethylene glycol monobutyl ether, ethylene glycol monoethyl ether, diethylene glycol monopropyl ether, diethylene glycol monobutyl ether, ethylene glycol dimethyl ether, ethylene glycol diethyl ether, ethylene glycol dibutyl ether, ethylene glycol monoethyl ether acetate, ethylene glycol monobutyl ether acetate, and ethylene glycol monoethyl ether acetate, or combinations of two or more of the foregoing, and the plasticizer (ii) is selected from DBT, dipentyl terephthalate, butyl benzyl phthalate, dihexyl phthalate and benzoate type plasticizers. In one class of this embodiment, the plasticizer (ii) is selected from DBT, dipentyl terephthalate and benzoate type plasticizers. In one class of this embodiment, the plasticizer (ii) is selected from DBT, dipentyl terephthalate (DPT) and dipropylene glycol di-benzoate. In one class of this embodiment, the compound of formula I is chosen from ethylene glycol monobutyl ether, ethylene glycol monoethyl ether, diethylene glycol monopropyl ether, diethylene glycol monobutyl ether, ethylene glycol dimethyl ether, ethylene glycol diethyl ether, ethylene glycol dibutyl ether, ethylene glycol monoethyl ether acetate, ethylene glycol monobutyl ether acetate, and ethylene glycol monoethyl ether acetate or combinations of two or more of the foregoing. In one subclass of this class, the plasticizer (ii) is selected from DBT, dipentyl terephthalate and benzoate type plasticizers. In one subclass of this class, the plasticizer (ii) is selected from DBT, dipentyl terephthalate (DPT) and dipropylene glycol di-benzoate. In one subclass of this class, the plasticizer (ii) is selected from DBT, dipentyl terephthalate (DPT) and dipropylene glycol di-benzoate.

In one embodiment, the compound of formula I is chosen from ethylene glycol monobutyl ether, ethylene glycol monoethyl ether, diethylene glycol monopropyl ether, diethylene glycol monobutyl ether, ethylene glycol dimethyl ether, ethylene glycol diethyl ether, ethylene glycol dibutyl ether, ethylene glycol monoethyl ether acetate, ethylene glycol monobutyl ether acetate, and ethylene glycol monoethyl ether acetate. In one embodiment, the plasticizer blend contains two or more of the foregoing compounds. In one class of this embodiment, the plasticizer (ii) is selected from DBT, dipentyl terephthalate and benzoate type plasticizers. In one class of this embodiment, the plasticizer (ii) is selected from DBT, dipentyl terephthalate (DPT) and dipropylene glycol di-benzoate. In one class of this embodiment, the plasticizer (ii) is selected from DBT, dipentyl terephthalate (DPT) and dipropylene glycol di-benzoate. In one class of this embodiment, the plasticizer is selected from DBT and dipentyl terephthalate.

In one class of this embodiment, the plasticizer blend comprises at least two compounds of formula I, the compound of formula I is chosen from ethylene glycol monobutyl ether and diethylene glycol monobutyl ether. In one subclass of this class, the plasticizer (ii) is selected from DBT, dipentyl terephthalate and benzoate type plasticizers. In one subclass of this class, the plasticizer (ii) is selected from DBT, dipentyl terephthalate (DPT) and dipropylene glycol di-benzoate. In one subclass of this class, the plasticizer (ii) is selected from DBT, dipentyl terephthalate (DPT) and dipropylene glycol di-benzoate.

In one embodiment, the compound of formula I is chosen from ethylene glycol monobutyl ether, diethylene glycol monobutyl ether, ethylene glycol 2-ethylhexyl ether, propylene glycol monomethyl ether, diethylene glycol monoethyl ether, diethylene glycol monopropyl ether, diethylene glycol monobutyl ether acetate and diethylene glycol monoethyl ether acetate. In one embodiment, the plasticizer blend contains two or more of the foregoing compounds. In one class of this embodiment, the plasticizer (ii) is selected from DBT and dipentyl terephthalate. In one subclass of this embodiment, the plasticizer blend comprises at least two compounds of formula I, the compound of formula I is chosen from ethylene glycol monobutyl ether and diethylene glycol monobutyl ether.

In one embodiment, the compound of formula I is selected from ethylene glycol monobutyl ether, diethylene glycol monobutyl ether and diethylene glycol monobutyl ether acetate or combinations of two or more of the foregoing, and the plasticizer (ii) is dibutyl terephthalate.

In one embodiment, the compound of formula I is diethylene glycol monobutyl ether (DB) and the plasticizer (ii) is DBT. In one embodiment, the compound of formula I is EB, the plasticizer (ii) is dipropylene glycol di-benzoate. In one embodiment, the compound of formula I is) EB the plasticizer (ii) is dipentyl terephthalate (DPT).

In some embodiments, the plasticizer blend comprises a second plasticizer having a boiling temperature of at least 340 degrees C. and a zero shear viscosity of no more than 15 centipoise at 25 degrees C.

In one embodiment, the second plasticizer is selected from dioctyl adipate (DOA), triethylene glycol 2-ethylhexanoate and diisononyl adipate. In one embodiment, the second plasticizer is dioctyl adipate

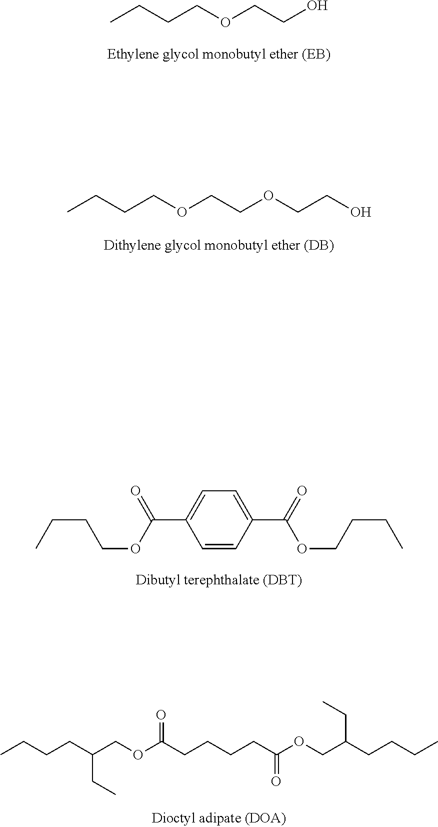

In one embodiment, the compound or compounds of formula I is present in the range above 0 weight % and up to 90 weight % based on the sum total of the plasticizer blend, and the plasticizer is present from 10 weight % to 90 weight % based on the sum total of the plasticizer blend. In one class of this embodiment, the compound or compounds of formula I is present from 30 weight % to 90 weight % based on the sum total of the plasticizer blend, and the plasticizer is present from 10 weight % to 70 weight % based on the sum total of the plasticizer blend. In one class of this embodiment, the compound or compounds of formula I is present from 40 weight % to 90 weight % based on the sum total of the plasticizer blend, and the plasticizer is present from 10 weight % to 60 weight % based on the sum total of the plasticizer blend. In one class of this embodiment, the compound or compounds of formula I is present from 50 weight % to 70 weight % based on the sum total of the plasticizer blend, and the plasticizer is present from 30 weight % to 50 weight % based on the sum total of the plasticizer blend.

In another aspect, the invention provides plastisols comprising polyvinyl chloride resin and any of the plasticizer blends of the present invention. Any of the plasticizer blends of the present invention, and any of the embodiments, classes, subclasses and sub-subclasses described above may be used.

In a further aspect, the invention provides a plastisol containing polyvinyl chloride resin and a plasticizer blend of the present invention, along with another plasticizer. The plastisol further contains one or more third plasticizers and optionally contains one or more additives chosen from stabilizers, anti-static agents, anti-fogging agents, ultra-violet inhibitors, antioxidants, light stabilizers, flame retardants, and pigments.

In one embodiment, the plastisols of the invention 0.1 to 20 contain weight percent of the plasticizer blend. In another embodiment, the plastisols contain 5 to 15 weight percent of a plasticizer blend. The plasticizer blend can be used as a secondary plasticizer or viscosity additive along with the one or more third plasticizer. In one embodiment, the third plasticizer is a general-purpose primary plasticizer. In one embodiment, the third plasticizer is selected from dioctyl terephthalate (DOTP), diisononyl cyclohexanoate (DINCH), diisononyl phthalate (DINP), dioctyl phthalate (DOP), diisodecyl phthalate (DIDP), or combinations of two or more of the foregoing.

In one embodiment, the PVC resin component of the plastisols of the present invention generally have a degree of polymerization (DP) which is between 650 and 1600 and an inherent viscosity (IV) between 0.5 and 1.4 (based on ASTM D-1243). In one embodiment, the PVC resin component of the plastisols of the present invention has a degree of polymerization or between 900 and 1100, The PVC-based resin of the present invention may be formulated from a single PVC resin or a mixture of two or more different PVC resins. In certain embodiments, two or more different PVC resins are used to optimize viscosity and fusion properties.

The plastisols of the present invention can be molded, spread, sprayed, coated or processed into a variety of applications.

| Components | phr |
|---|---|
| Geon ™ 121A Dispersion PVC resin | 100 |
| Plasticizers | 60 |
| Drapex ® 6.8 ESO | 3 |
| AkcrostabTM LT-4798 | 3 |

The plasticizer compositions of the present invention may contain one or more stabilizers such as metal soaps, organic phosphites, epoxy compounds, tin stabilizers, and mixtures thereof. The stabilizers provide protection against deficient PVC homopolymerization and copolymerization, and functions to eliminate or retard the process of polymer degradation. The total amount of stabilizer present in the compositions typically ranges from 0.1 to 10 phr, from 1 to 7 phr, or 2 to 5 phr. In certain embodiments, the stabilizer is a mixture of metal soaps and epoxy compounds, or a mixture of metal soaps, epoxy compounds and organic phosphites.

Metal soap stabilizers include zinc stearate, barium stearate, calcium stearate, cadmium stearate, barium ricinolate, calcium oleate, calcium laurelate, zinc octoate, and mixtures thereof. In certain embodiments, the metal soap stabilizers are mixtures of barium stearate, zinc stearate and cadmium stearate. An example of a barium stearate/zinc stearate mixture is sold by Bearlocher (Chemgrade UBZ-791), and calcium stearate/zinc stearate and barium stearate/cadmium stearate mixtures are sold by Akzo and Interstab. (CZ-19A and BC-103L, respectively). Epoxy compound stabilizers include epoxy soybean oil, e.g., Srapex 6.8, ESO, epoxy linseed oil, epoxy polybutadiene, epoxy methylstearate, epoxy stearate, epoxy ethylhexyl stearate, epoxy stearyl stearate, epoxy propyl isocyanalate 3-(2-case INO)-1,2-epoxy propane, bis-phenol A diglycidyl ether, vinyl dicyclohexanediepoxide, 2,2-bis-(4-hydroxyphenol) propane and epichlorohydrine condensation copolymeration, and mixtures thereof. Organic phosphite stabilizers include diphenyldecyl phosphite, triphenyl phosphite, tris-nonylphenyl phosphite, tri-steareal phosphite, octyldiphenyl phosphite, and mixtures thereof. Tin stabilizers include tin dilaurate, dibutyl tin maleate, organic tin mercaptide and organic tin sulfonic amide, and mixtures thereof.

The above stabilizers may be used individually or in any combination. In certain embodiments, the stabilizers are mixtures of zinc stearate, barium stearate, calcium stearate, and epoxy compounds. In one embodiment, the epoxy stabilizer is epoxy soybean oil. In addition, organic phosphites may be used in conjunction with the zinc stearate, barium stearate, cadmium stearate, and epoxy compound mixtures. In certain embodiments, the stabilizer mixtures are barium stearate/zinc stearate and epoxy soybean oil, calcium stearate/zinc stearate and epoxy soybean oil, and barium stearate/cadmium stearate and epoxy soybean oil. The plastisols of the present invention may further comprise additional additives, such as anti-static agents, anti-fogging agents, ultra-violet inhibitors, anti-oxidants, light stabilizers, fire retardants, pigments, and mixtures thereof. These additives are generally known in the art and may be present in the compositions in an amount sufficient to impart the desired property (generally below 10 phr). Anti-static and anti-fogging agents include sorbitan fatty ester, sorbitol fatty ester, and glycerine fatty ester.

The invention further comprises methods comprising fusing the plastisols of the present invention. Many methods for fusing plastisols are known, and any effective method for fusion can be used.

The invention further comprises articles comprising fused plastisols of the present invention. The article can be formed through any effective process, such as molding, spreading, spraying, or coating with the plastisol, followed by fusing. In one embodiment, the article is selected from floor coverings (e.g. vinyl sheet flooring), toys, wall coverings, (e.g. wallpaper), tubing, inks, decals, packaging, gloves, fibers, upholstery, bristles, shoe soles, belting, film finishes, garments, calendared film and coated fabrics. In one embodiment, the article is selected gloves, toys, flooring and coated fabrics. In one class of this embodiment, the coated fabric is synthetic leather.

### Experimental Section

### Plastisol Preparation

Solid and liquid components of the formulation were weighed into 300 max long Flack Tek containers. Each sample was mixed using a Flack Tek DAC 600.2 VAC Speed Mixer™ operated at 1600 rpm for 40 second intervals. Temperature was monitored between mixing intervals to ensure the plastisol did not rise above 35° C. Once samples were thoroughly mixed with a smooth consistency, they were then deaerated for 20 min under vacuum (˜75 Torr) at 1000 rpm.

### Viscosity Measurement

Plastisol viscosity was measured on a TA Instruments DHR-1 rotational rheometer. Viscosity was measured at 40° C. with a 40 mm aluminum parallel plate.

### Fusion Temperature Measurement

Fusion temperature is measured by using DHR-1 Parallel Plate Rheometer. Samples were analyzed on a TA Instruments DHR-1 parallel plate rheometer, fitted with an Environmental Test Chamber, 25 mm parallel plate geometry, set to a 1000 micron gap. A temperature sweep from 40-150° C. was run in oscillation mode with a heating rate of 5° C./min. On the resulting plots, the temperature at the maximum of the complex viscosity curve is taken as the fusion point.

### Freezing Point Measurement

Approximately 10 g plasticizer sample was weighed into 4-dram vials and placed into a water bath containing 1:1 deionized H₂O: ethylene glycol that can be set to a minimum of −35° C. After cooling for 24 hours, the samples were removed and visually inspected to see if any solid/crystal formation. The freezing temperature is defined as the temperature that solid/crystal starts to show based on visual inspection.

### Weight Loss Test

ASTM D2369-10: Standard Test Method for Volatile Content of Coatings.

### Examples 1-2

The composition of exemplary glycol ether/fast fuser blends are listed in Table 1. DBT by itself has a melting temperature of about 15° C., which makes processing DBT challenging at lower temperatures. Addition of EB solvent can greatly depress the freezing point of the EB/DBT blends (Table 2). It was found that a 40 weight % DBT concentration is desired to allow the blend being processable at relatively low ambient temperature.

TABLE 1
Composition of fast fuser blends and their freezing points.

| Plasticizer | | | Freezing |
|---|---|---|---|
| Composition | EB | DBT | Temperature |
| Example | (weight %) | (weight %) | (° C.) |
| 1 (Comparative) | 0 | 100 | 15 |
| 2 | 10 | 90 | 6 |
| 3 | 30 | 70 | 0 |
| 4 | 50 | 50 | −4 |
| 5 | 60 | 40 | −17 |
| 6 | 70 | 30 | −30 |

2,2,4-Trimethyl-1,3-pentanediol diisobutyrate (available from Eastman Chemical Company as TXIB) is an example of a plasticizer that confers favorable fast fusion and low viscosity properties. One of the challenges of using TXIB is its high volatility. Weight loss of plasticizers were measured after heating at 110° C. for 60 mins at ambient pressure. EB/DBT blends (Exampled 5 and 6) showed much less weight loss when compared to TXIB (Table 3). Lower volatility can allow manufacturers to reduce emissions, and more importantly, reduce production cost since more raw material is retained in the final products.

TABLE 2
Weight loss of plasticizers after heating at 110° C. for 60 mins.

| Plasticizer | TXIB | Example 5 | Example 6 |
|---|---|---|---|
| Weight loss % | 99.94 | 68.34 | 79.42 |

A typical PVC plastisol formulation with low viscosity additives is as shown in Table 3, with additive levels expressed phr.

TABLE 3
PVC plastisol formulations with various additives.

| | Amount |
|---|---|
| Components | (phr) |
| Dispersion PVC - Geon ™ 121 (phr) | 100 |
| Eastman ™ DOTP (phr) | 70 |
| Drapex ® 6.8 ESO (phr) | 0.5 |
| Akcrostab ™ LT-4798 (phr) | 0.5 |
| Viscosity reducing component | 10 |

PVC plastisol formulations we prepared according to Table 3 using a variety of viscosity reducing components, specifically TXIB, DBT (Comparative Example 1), and DBT/EB blends (Examples 5 and 6). Viscosity of these plastisols as well as Fusion temperature were assessed. Fusion temperature measures the temperature that a plasticized PVC solidifies (e.g., film) to give the solid the desired mechanical strength. Results are presented in Table 4.

TABLE 4
Viscosity and Fusion Temperatures

| | Viscosity | Viscosity | Fusion |
|---|---|---|---|
| Viscosity-reducing | at 2.5 s⁻¹ | at 100 s⁻¹ | Temperature |
| component | (cP) | (cP) | (° C.) |
| TXIB (comparative) | 364 | 529 | 132.5 |
| Example 1 (comparative) | 389 | 574 | 121.2 |
| Example 5 | 315 | 310 | 128.1 |
| Example 6 | 306 | 289 | 128.6 |

The efficiency in reducing the viscosity is a key performance requirement for viscosity reduction additives. As shown in Table 4, both EB/DBT blends (Ex 5 and 6) outperformed both DBT alone and TXIB in reducing plastisol viscosity. More importantly, Plastisols prepared from EB/DBT blends exhibit much lower viscosity at high shear rate regime, which can greatly benefit the applications that involve high shear rate processing (e.g. knife coating, blow coating, etc.).

The blend of EB/DBT effectively reduces the fusion temperature due to the fast fusion character of DBT (Table 6). Plastisols with lower fusion temperatures can be fused with lower oven temperatures or the line speed can be increased for higher productivity.

Plasticizer blends were prepared using blends of DBT with a variety of glycol ether and glycol ether or glycol ether ester compounds (collectively, “glycol compounds”), specifically DB, EEH, PM, DE, DP, DBA and DEA (abbreviations explained above). In all cases, the blends were 30% DBT and 70% glycol ether or glycol ether ester, with all percentages being by weight, except that the blend Example 8 was 40% DBT and 60% DB. Results are presented in Table 5, and comparative data regarding TXIB and Comparative Example 1 are repeated. “PZ blend” refers to a blend of DBT and the compound of formula I. Once again, examples 7-14 outperformed both DBT alone and TXIB in reducing plastisol viscosity

TABLE 5
Composition of fast fuser blends and their freezing points.

| | | PZ or PZ | PZ or PZ/ | Plas- | Plas- | |
|---|---|---|---|---|---|---|
| | | blend | Glycol | tisol | tisol | Plas- |
| | Ether/ | Blend | Blend | Viscos- | Viscos- | tisol |
| | ester | Weight | Freezing | ity at | ity at | Fusion |
| Exam- | com- | Loss | Temp | 2.5 s⁻¹ | 100 s⁻¹ | Temp |
| ple | pound | % | (° C.) | (cP) | (cP) | (° C.) |
| 7 | DB | 79.4 | −18 | 314 | 306 | 128.5 |
| 8 | DB | 64.6 | −10 | 338 | 330 | 127.1 |
| | (60%) | | | | | |
| 9 | EEH | 77.8 | −18 | 269 | 293 | 130.2 |
| 10 | PM | 75.7 | −16 | 311 | 305 | 125.5 |
| 11 | DE | 75.2 | −16 | 335 | 335 | 126.7 |
| 12 | DP | 75.8 | −16 | 271 | 279 | 128.1 |
| 13 | DBA | 77.2 | −17 | 262 | 267 | 129.4 |
| 14 | DEA | 76.2 | −18 | 292 | 306 | 127.5 |
| TXIB | na | 99.9 | −70 | 364 | 529 | 132.5 |
| 1 (Comp) | na | 34.6 | 15 | 389 | 574 | 121.2 |

Compatibility of plasticizers with PVC is desirable to reduce migration and exudation from plasticized PVC. Loop spew test (pursuant to ASTM D3291-11: Standard Practice for Compatibility of Plasticizers in Poly(Vinyl Chloride) Plastics Under Compression) was used to study the exudation tendency of plasticizers within a polymeric matrix. As shown in Table 6, plastisol formulations prepared as described in Table 3 using the plasticizer compositions of Examples 5, 6 and 7 exhibited good compatibility with PVC compound, and no signs of exudation was observed after the 7 days testing period. The results in Table 6 are expressed as an average for four testing specimens. After 4 hours, the average of four specimens was 0.25, but after 4 hours, no exudation was observed.

TABLE 6
Loop spew exudation results of PVC
films with various plasticizers.

| | | Viscosity Reducing Agent in PVC Used to Prepare Films | | |
|---|---|---|---|---|
| Elapsed Time | | Example 5 | Example 6 | Example 7 |
| 4 | hours | 0.25 | 0.25 | 0 |
| 1 | day | 0 | 0 | 0 |
| 7 | days | 0 | 0 | 0 |

0 = no exudation,
1 = slight exudation,
2 = moderate exudation,
3 = severe exudation

In one embodiment, the plasticizer composition is a blend containing an ether compound and two or more plasticizers. One example is a ternary blend of EB, DBT and DOA (Example 15) to further reduce the volatility of the compound, which could be used in applications that require low volatility or emissions (Table 7). Jayflex™ MB10 is a commonly used low volatility, viscosity reducer and was used with Comparative Example 16. As shown in Table 8, The weight loss of EB/DBT/DOA at 110° C. is very comparable to that of Jayflex™ MB10 (Table 8). Furthermore, most to all of the EB component is evaporated during the fusion process, leaving only the DBT and DOA in the final product. DBT and DOA has lower volatility than Jayflex™ MB10. As a result, end products containing a blend of DBT and DOA can have lower VOC emission during their use as compared to end products containing Jayflex™ MB10.

TABLE 7
Composition of an exemplary EB/DBT/DOA blend.

| | EB | DBT | DOA |
|---|---|---|---|
| Example | (weight %) | (weight %) | (weight %) |
| 15 | 30 | 40 | 30 |

TABLE 8
Weight loss of plasticizers after heating at 110° C. for 60 mins.

Viscosity Reducing Agent

| | Example 15 | Comparative Ex. 16 |
|---|---|---|
| Weight Loss % | 37.36 | 38.55 |

PVC plastisol formulations prepared in accordance with Table 3 were prepared in which the viscosity reducing components were Example 15 and 16. Viscosities of plastisol formulations with various additives are summarized in Table 6. The ternary blend of EB, DBT and DOA (Example 15) can significantly lower the viscosity of PVC plastisol, especially in high shear rate regime. When compared to Jayflex™ MB10 (Comparative Example 16), the EB/DBT/DOA blend (Example 15) can also lower the fusion temperature, allowing manufacturers to lower energy consumption or increase productivity.

TABLE 9
Viscosity of plastisols measured at 40° C. and fusion temperatures.

Viscosity Reducing Agent

| | Example 15 | Comparative Ex 16 |
|---|---|---|
| Viscosity at 2.5 s⁻¹ (cp) | 322 | 376 |
| Viscosity at 100 s⁻¹ (cp) | 357 | 540 |
| Fusion Temp (° C.) | 130.4 | 131.8 |

This invention can be further illustrated by the following examples of preferred embodiments thereof, although it will be understood that these examples are included merely for purposes of illustration and are not intended to limit the scope of the invention unless otherwise specifically indicated.

1. A plasticizer blend comprising:
(i) a compound of formula I: 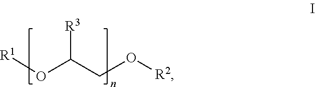
wherein:
R¹ and R² are independently hydrogen, (C₁-C₈)alkyl, or (C₁-C₈)alkyl-C(O)—, no more than one of R¹ and R² is hydrogen, no more than one of R¹ and R² contains an alkyl-C(O)—, R³ is hydrogen or (C₁-C₈)alkyl, and n is an integer of from 1 to 3; and
(ii) a plasticizer, wherein said plasticizer, when combined at 60 parts per hundred polyvinyl chloride resin (“phr”) with components consisting of (a) and (b) to form a reference plastisol, with (a) and (b) being:
(a) a polyvinyl chloride resin, said polyvinyl chloride resin being a homopolymer having a K value of 74 at 100 phr, and
(b) an epoxidized soybean oil having 7.0 percent oxirane oxygen content at 3 phr,
provides the reference plastisol having a fusion temperature of less than 121° C., as measured using a TA Instruments DHR-1 parallel plate rheometer fitted with an environmental test chamber, 25 mm parallel plate geometry, set to a 1000-micron gap with a temperature sweep from 40-150° C. run in oscillation mode with a heating rate of 5° C./min, wherein the fusion temperature is defined as the maximum temperature of the complex viscosity curve.

2. The plasticizer blend of claim 1, wherein the compound of formula I is chosen from ethylene glycol monobutyl ether, ethylene glycol monoethyl ether, diethylene glycol monopropyl ether, diethylene glycol monobutyl ether, ethylene glycol dimethyl ether, ethylene glycol diethyl ether, ethylene glycol dibutyl ether, ethylene glycol monoethyl ether acetate, ethylene glycol monobutyl ether acetate, and ethylene glycol monoethyl ether acetate.

3. The plasticizer blend of claim 1, wherein the compound of formula I is selected from ethylene glycol monobutyl ether diethylene glycol monobutyl ether and diethylene glycol monobutyl ether acetate, and the plasticizer is dibutyl terephthalate.

4. The plasticizer blend of claim 1, wherein none of the alkyls is cyclic.

5. The plasticizer blend of claim 1, wherein R¹ and R² are independently hydrogen, (C₁-C₈)alkyl, or (C₁-C₄)alkyl-C(O)—.

6. The plasticizer blend of claim 1, wherein R¹ and R² are independently hydrogen, (C₁-C₈)alkyl, or (C₁-C₂)alkyl-C(O)—.

7. The plasticizer blend of claim 1 wherein R¹ or R² is hydrogen.

8. The plasticizer blend of claim 1 wherein n is 1 or 2.

9. The plasticizer blend of claim 1 wherein R³ is hydrogen or C₁ alkyl.

10. The plasticizer blend of claim 1, wherein the plasticizer blend comprises more than one compound of formula I.

11. The plasticizer blend of claim 10, wherein the more than one compound of formula I comprises a glycol ether ester and an ether selected from glycol ethers and dialkyl ethers.

12. The plasticizer blend of claim 10, wherein from 10 weight % to 90 weight % based on the sum total of the plasticizer blend consists of one or more compounds of formula I.

13. The plasticizer blend of claim 1, wherein the plasticizer is chosen from dibutyl terephthalate, dipentyl terephthalate, benzyl butyl phthalate, and benzoate plasticizers.

14. The plasticizer blend of claim 1, wherein the plasticizer blend further comprises a second plasticizer having a boiling temperature higher than at least 340 degrees C. and a zero shear viscosity of no more than 15 centipoise at 25 degrees C.

15. The plasticizer blend of claim 14, wherein the second plasticizer is dioctyl adipate.

16. A plastisol comprising polyvinyl chloride resin and the plasticizer blend of claim 1.

17. The plastisol of claim 16, further comprising one or more additives chosen from stabilizers, anti-static agents, anti-fogging agents, ultra-violet inhibitors, antioxidants, light stabilizers, flame retardants, and pigments.

18. The plastisol of claim 16, wherein the plastisol further comprises dioctyl terephthalate, diisononyl cyclohexanoate, diisononyl phthalate, dioctyl phthalate, diisodecyl phthalate, or combinations of two or more of the foregoing.

19. An article comprising a fused plastisol formed by fusing the plastisol of any of claim 16.

20. A method for making a plastisol, comprising fusing the plastisol of claim 16.
